(19) United States
(12) Patent Application Publication
(10) Pub. No.: US 2009/0232469 A1
(43) Pub. Date: Sep. 17, 2009

(54) METHOD AND APPARATUS FOR RE-CONSTRUCTING MEDIA FROM A MEDIA REPRESENTATION

(76) Inventors: Clinton Priddle, Upplands Vasby (SE); Per Frojdh, Stockholm (SE)

Correspondence Address: ERICSSON INC., 6300 LEGACY DRIVE, M/S EVR 1-C-11, PLANO, TX, 75024, US

(21) Appl. No.: 12/299,457

(22) PCT Filed: Apr. 27, 2007
(86) PCT No.: PCT/SE07/50284

§ 371 Date: Mar. 13, 2009

Related U.S. Application Data
(60) Provisional application No. 60/746,278, filed on May 3, 2006.

(51) Int. Cl. H04N 5/93; H04N 7/12

(52) U.S. Cl. 386/52; 375/240.26; 375/E07.076

(57) ABSTRACT

The present invention relates to a new type of random access point adapted to be included in a media representation comprising a plurality of data objects. The random access point is characterized by a reference to a data element in another data object of said plurality of data objects, wherein said referenced data element at least partly describes how to reconstruct media from said media representation. The invention further relates to a method and apparatus of reconstructing media from a media representation. The method comprises receiving a data object comprising at least one reference to a data element in another data object of the media representation; and re-constructing the media by use of information associated with said referenced data element(s).

### FIELD OF THE INVENTION

The present invention relates to the field of data communication, and in particular to the field of reconstructing media in a media representation.

### BACKGROUND

In many data communication methods where media is conveyed in the form of a data sequence such as video and audio, data is often compressed in a manner so that only the differences between scenes is encoded into a data sequence, rather than encoding and transmitting data describing the entire scene for each scene of a sequence of scenes.

However, it is often essential that a potential receiver of the data can tune in to a transmission session that has commenced at an earlier point in time. Such a transmission session could for example be a broadcast, multicast or streaming session. For example, if the communicated information is a video or audio sequence that is being broadcasted, provisions are often desired for facilitating for a receiver to tune in to the broadcasted sequence mid-sequence, even if the receiver has not received the initial part of the data sequence.

This can be solved by providing so called Random Access Points in the file or data stream by which the data sequence is being transmitted, by which Random Access Points a scene in the sequence of scenes can be re-constructed. A Random Access Point is a data object which can be used as an entry point to a file or data stream, without any knowledge of previous data objects. For example, in video compression formats, INTRA images, which are self-contained, are employed for this purpose. Since an INTRA image comprises an entire scene and does not rely on differences between scenes, a decoder can use an INTRA image to start the decoding from scratch at the scene location of the INTRA image.

Similar Random Access Points have been contemplated in the Dynamic and Interactive Multimedia Scenes (DIMS) standard currently being standardized by the 3^{rd} Generation Partnership Project (3GPP), see 3GPP S4-AHP255: “MORE Technical Proposal for Dynamic and Interactive Multimedia Scenes” and ISP/IEC 14496-20/FDIS: “Information technology—Coding of audio-visual objects—Part 20: LASeR (Lightweight Applications Scene Representation)”, editing draft as of November 8^{th}, 2005.

However, the provision of Random Access Points comprising the entire data defining a scene involves the transmission of a high amount of redundant data that most receivers will already have received. In many data communication methods, transmission bandwidth is a scarce resource, and it is desirable to reduce the amount of redundant data transmitted by an application.

### SUMMARY

A problem to which the present invention relates is how to reduce the amount of bandwidth required by a data sequence representing media comprising a sequence of scenes.

This problem is addressed by a method of reconstructing media from a media representation wherein the media representation includes a plurality of data objects comprising at least one data element. The method comprises receiving a data object including at least one reference to a data element in another data object of the media representation; and re-constructing the media by use of information associated with said referenced data element(s).

The problem is further addressed by an apparatus for reconstructing media from a media representation including a plurality of data objects comprising at least one data element. The apparatus comprises an input for receiving the media representation, and is arranged to identify, in the received media representation, a data object that comprises a reference to a data element in another data object of the media representation. The apparatus if further arranged to reconstruct media by using said reference.

The invention also discloses a data object adapted to be included in a media representation comprising a plurality of data objects, and an apparatus for creating a media representation comprising said data object. The data object comprises a reference to a data element in another data object of said plurality of data objects, wherein said referenced data element at least partly describes how to reconstruct media from said media representation.

By the inventive method, apparatus and data object is achieved that a random access point may be provided in a media representation wherein the random access point does not contain all the information required to re-construct a scene. Hence, random access points may be provided at a lower bandwidth cost.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically illustrates a data communications system.

FIG. 2 schematically illustrates an example of a media representation.

FIG. 3 schematically illustrates an embodiment of the inventive method.

FIG. 4a schematically illustrates an example of media in the form of a sequence of scenes as well as a corresponding media representation in the form of a data sequence.

FIG. 4b schematically illustrates a distributed random access point to be used in the example illustrated by FIG. 4a.

FIG. 5 illustrates an example of a distributed random access point.

FIG. 6 schematically illustrates a decoder according to an embodiment of the invention.

### DETAILED DESCRIPTION

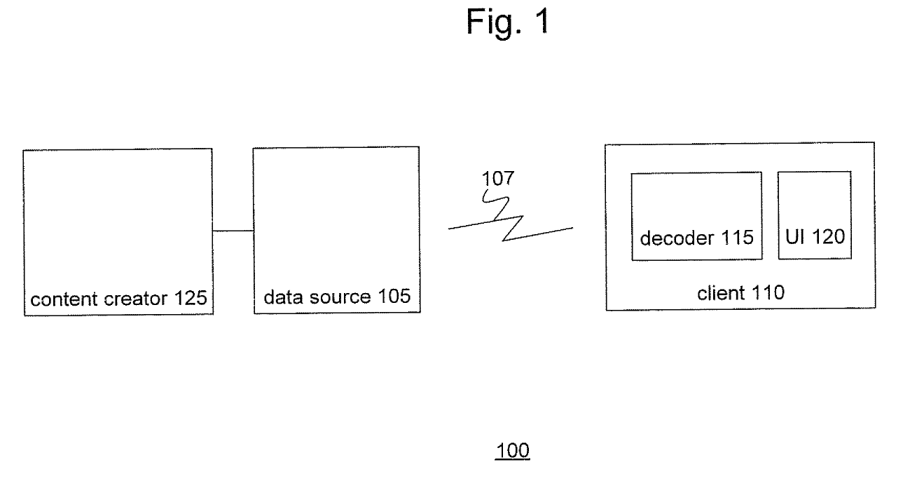

FIG. 1 schematically illustrates a data communications system 100, comprising a data source 105 and a client 110 which are interconnected by means of a connection 107. Client 110 comprises a decoder 115 for decoding a media representation received in the form of a data sequence, which may for example have been provided by the data source 105, in order to retrieve media which is represented by the media representation. Hence, by means of the decoder 115, media can be re-constructed from a data sequence representing the media. Client 110 can also be associated with device 120 for processing the decoded sequence of information, such as a user interface or an application.

In FIG. 1, connection 107 is illustrated to be a radio connection. The connection 107 may alternatively be a wired connection, or a combination of wired and wireless. Furthermore, the connection 107 will often be realised by means of additional nodes interconnecting the data source 105 and the client 110, such as a radio base station and/or nodes providing connectivity to the Internet. Alternatively, connection 107 is a direct connection. An example of a data communications system 100 wherein the connections 107 is a direct connection is a system 100 wherein the data source 105 is a DVD disc and the client 110 is a DVD player.

Data communications system 100 of FIG. 1 is also shown to include a content creator 125. Content creator 125 is adapted to create the file or data stream, comprising a data sequence to be transmitted to the client 110, from data representing the media (which may for example be in the form of a sequence of scenes) to be presented at a user interface/application 120. Although the term scene may be literally interpreted as a part of a visual representation such as a video sequence, it should here be re-construed to refer to a description of any media representation at a particular point in time, including for example audio, multimedia and interactive multimedia representations as well as video and synthetic video.

The content creator 125 typically comprises an encoder for encoding a sequence of scenes into a data sequence (wherein the data sequence may be of a compressed format). Such data sequence will in the following be referred to as the media representation of the sequence of scenes. In some implementations of the invention, the content creator 125 is completely separate from the data source 105, as is the case in the DVD example mentioned above. In other implementations, the content creator 125 may also be the data source 105, as may be the case in real-time streaming of data.

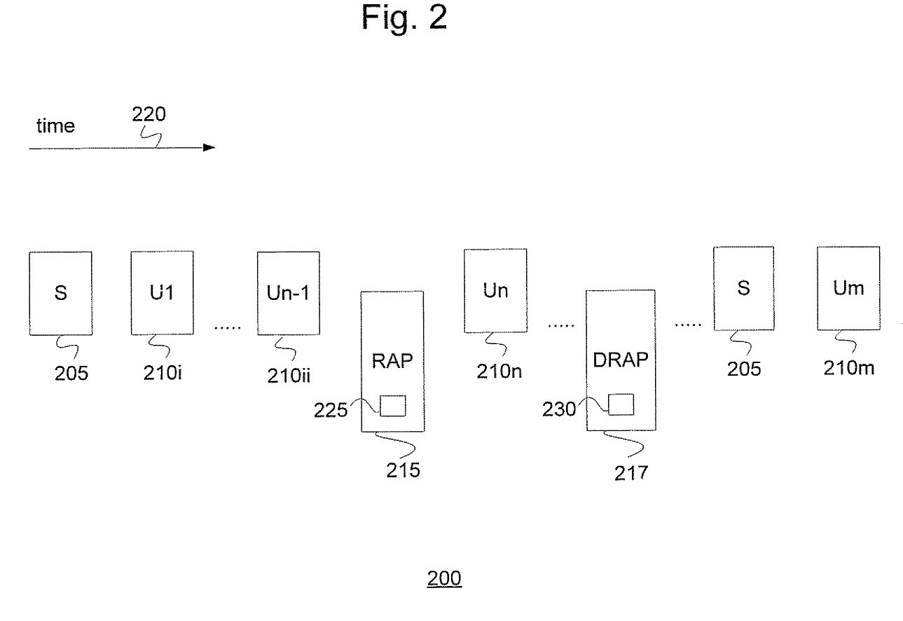

An example of a media representation 200 to be transmitted to a client 110 from a data source 105 in the form of a data sequence in a file or data stream is schematically illustrated in FIG. 2. The media representation 200 comprises a number of data objects which have been encoded in a manner so that a first scene data object 205 comprises data describing an entire scene of the sequence of scenes to be presented at a user interface 120, whereas other data objects, referred to as update data objects 210, comprise data relating to the differences between the current scene and the previous scene of the sequence of scenes. Updates by use of update data objects may be performed according to REX (Remote Events for XML), by use of LASeR commands, or any other updating method. A data sequence may contain multiple scene data objects 205. The file or data stream comprising the media representation 200 may be referred to as a media container. The media container may for example be downloaded to a client 100 in a single downloading session, may be downloaded to the client 110 in parts, may be streamed to the client 110, or may be progressively downloaded. For example a scene data object 205 may initially be downloaded to a client 110, and update data objects 210 may be streamed to the client 110 as the scene requires updating.

An update data object 210 taken by itself, or even a series of update data objects, does normally not contain sufficient information to re-construct a scene. Hence, a client 110 can normally not tune in to the data sequence of media representation 200 by decoding the update data objects 210 only. Since scene data objects 205 contain all the data necessary to re-construct a scene, a scene data objects 205 may be used as an access point to the media representation—a scene data object 205 is a type of Random Access Point (RAP). However, since the frequency of scene data objects 205 required in media representation 200 in order to represent a sequence of scenes is normally not sufficient for providing efficient tuning-in possibilities, other Random Access Points 125 may advantageously be included in the media representation 200 in order to facilitate for a client 110, which has not received all of the previous data objects of the media representation 200, to tune into the media representation 200. A conventional Random Access Point 215 includes all the information required to re-construct a scene of the sequence of scenes. A random access point 215 may be redundant or essential, a scene data object 205 being an essential Random Access Point. A redundant Random Access Point 215 contains information that clients 110, which are tuned in to the media representation 200, will already have received. Hence, an already tuned-in client 110 that experiences no error may ignore a random access point 215 and decode the update 210n, appearing directly after the Random Access Point 215, directly after having decoded the update 201n−1, appearing directly before the Random Access Point 215 in media representation 200. A redundant Random Access Point 215 can advantageously include identification data 225 identifying the Random Access Point 215 as redundant, such as a flag in the header of a data packet of a data stream, or a pre-determined sequence of bits in a file.

As mentioned above, a conventional Random Access Point 215 contains data describing the entire scene that is to be presented by the client 110 at the relevant point in time. A client 110 that has received such Random Access Point 215 will have all data necessary to retrieve the remaining part of the sequence of scenes to be conveyed by the remaining part of the media representation 200. However, the representation of all the necessary data for describing a scene requires a large amount of data, and hence the transmission of such a data object requires a large amount of bandwidth.

In the present invention, it is recognised that a data object 205, 210, 215 generally comprises data elements that may be copied (normally, each of the data objects in a data sequence comprises at least one data element). According to the invention, a new type of random access point data object 217 is introduced, which may contain references to data elements in other data objects 205, 210, 215 in the media representation 200. By means of such referenced data elements (possibly in combination with data elements included in the new type of random access point data object itself), a self-contained random access point may be obtained.

Since the necessary data for obtaining a random access point are distributed to the new type of random access point data object and at least one other data object 205, 210, 215, the new type of random access point data object, comprising references to other data objects, will in the following be referred to as a Distributed Random Access Point (DRAP) 217. A decoder 115 receiving the media representation 200 comprising a DRAP 217 may copy data elements of other data objects 210 to which references are included in DRAP 217 when the other data objects have been received and thus to obtain a self-contained random access point. Hence, according to the invention, a DRAP 217 need not contain all the data required to obtain a random access point, but may instead include a reference to data elements in one or more other data objects 205, 210, 215. Such references generally require considerably less bandwidth than the data elements to which they refer.

As discussed above, a scene data object 205 is a type of conventional random access point 125 that facilitates the reconstruction of an entire scene. When the reconstruction of an entire scene is desired by means of a DRAP 217, a DRAP 217 included in a media representation 200 would include references such that, after the referenced data elements have been copied into the DRAP 217, an entire scene may be re-constructed.

DRAPs 217 can be used in any type of media representation, including primary and secondary streams according to the DIMS standard. In a secondary stream, update data objects 210 are delivered to the client 110 in a different data sequence than the original scene data object 205, whereas in a primary stream, update data objects 210 are delivered in the same data sequence as the original scene data object 205. Secondary streams are often used if only a part of a scene is to be updated, such as for example a window displaying rapidly changing information in a background scene. If the background scene has been delivered (for example down-loaded) to the client 110 in a primary stream at an earlier point in time, any updates to the part of the scene that needs updating can be conveyed by means of a secondary stream. A secondary stream may advantageously include random access points in the form of DRAPs 217, in order for new clients 110 to tune in to the secondary stream of updates, or for clients 110 already listening to the secondary stream to refresh the part of the scene to which the update data objects of the secondary stream relate.

Furthermore, there are other applications in which a random access point does not need to describe an entire scene. For example, when a scene is streamed via multiple servers, the different servers may be arranged to update different parts of a scene. A self-contained random access point need in this case only describe the part of the scene which is updated by the relevant server, and hence a DRAP 217 will only have to relate to the part of the scene which is updated by the relevant server.

Hence, as described above, the execution of a DRAP 217 will in some cases result in re-construction of parts of a scene, rather than in the re-construction of an entire scene. In order to simplify the description, the term re-construction of a scene will in the following be used to refer to the re-construction of parts of the scene, or the reconstruction of an entire scene, whatever is applicable.

A DRAP 217 may be seen as a template for a conventional random access point 215 into which necessary information may be cut and pasted from other data objects 210.

A DRAP 217 can advantageously include identification data 230 identifying the DRAP 217 as a DRAP 217, such as a flag in the header of a data packet of a data stream, or a pre-determined sequence of bits in a file.

The other data objects 205, 210, 215 to which a DRAP 217 refers could be data objects that occur before, or after, the DRAP 217 in the media representation 200. In case the DRAP 217 refers to previous data objects, the DRAP 217 may be executed by clients 110 that have had access to the previous data objects. For example, if the data sequence is in a file, a client 110 reading the file may read data objects that occur before the DRAP 217. When the data sequence is in a data stream, a client 110 that have listened to the data objects to which references have been made, and stored such data objects in a memory, may execute the DRAP 217. When reference is being made in DRAP 217 to subsequent data objects 205, 210, 215, the execution of the DRAP 217 can occur when all the referenced data objects have been received, or at a later time. Thus, by waiting for subsequent data objects 205, 210 in order to obtain all the data required to re-construct a complete scene that can be used for tuning in to the media representation 200, the amount of data that has to be transmitted in a random access point can be reduced.

In the following, in order to simplify the description, a DRAP 217 will be described as referring to update data objects 210 only. However, it should be understood that a DRAP 217 may refer to any type of data object in a data sequence.

The invention is applicable to all methods of conveying media by means of a media representation comprising a sequence of data objects. The invention is particularly applicable to DIMS (Dynamic and Interactive Multimedia Scenes), which is an adaptation of SVG for mobile radio communication, presently using a version of SVG referred to as SVG Tiny 1.2 and wherein a scene can be composed temporally as well as spatially. DIMS is presently being standardised by 3GPP (3^{rd} generation partnership project). The invention is equally applicable to other methods of media, such as for example LAsER, defined in ISO/IEC 14496-20: “Information technology—Coding of audio-visual objects—Part 20: LASeR (Lightweight Applications Scene Representation)”

In many instances, data included in update data objects 210 of a data sequence will not be sufficient for re-constructing a particular scene. In such instances, a DRAP 217 will comprise i) references to data included in other data objects 210 and ii) data which should be used in re-constructing a scene in combination with the referenced data in other data objects 210. A DRAP 217 may advantageously also includes information relating to at which point in time sufficient data has been received and a scene may be re-constructed.

Other information may also optionally be included in a DRAP 217, such as information about possible updates that should be made to the scene which has been re-constructed by use of the referenced data elements. Subsequent updates of data may be necessary for instance if data, included in a DRAP 217 and to be used in the reconstruction of a scene, were copied from previously conveyed data objects 210 when the DRAP 217 was encoded. For instance, if the data relates to an element which moves across the screen in a sequence of video information, the element will need a different starting point if introduced in a DRAP 217 than if it had been introduced in an earlier update 210. For this purpose, update data may be added to the DRAP 217. The information on updates contained in the update data, if any, may advantageously relate to updates which are to be performed after the referenced data elements have been copied and before re-constructing the scene.

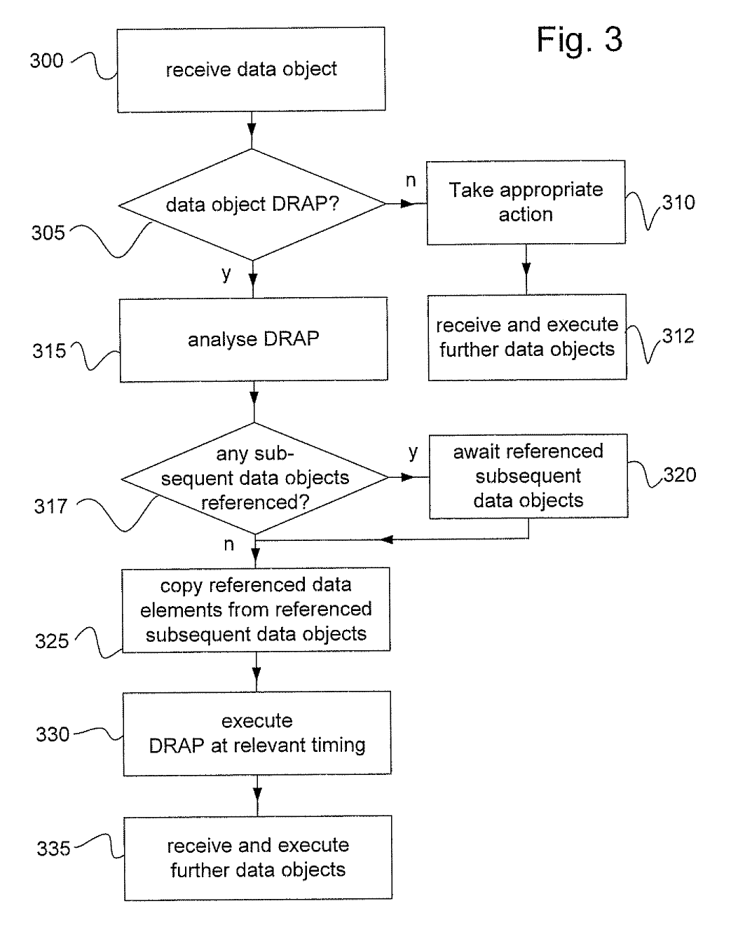

A flowchart schematically illustrating an aspect of the invention is illustrated in FIG. 3. In step 300, a data object is received by a client 110 that for some reason requires a random access point—for example in order to tune in to a data sequence of a media representation 200, to perform a reset or to navigate in a file. In step 305, it is checked whether the received data object is a Distributed Random Access Point 125. This could include checking of an identification 230 of DRAP 217. If it is found that the received data object is not a DRAP 217, then step 310 is entered, in which appropriate action is taken. In some implementations of the invention, both conventional Random Access Points and Distributed Random Access Points may be implemented. If the receive data object is a conventional Random Access Point 215, the Random Access Point 215 will be executed in step 310, or ignored, whatever is appropriate. Step 312 is entered after step 310, in which any further update data objects 210 are received and executed.

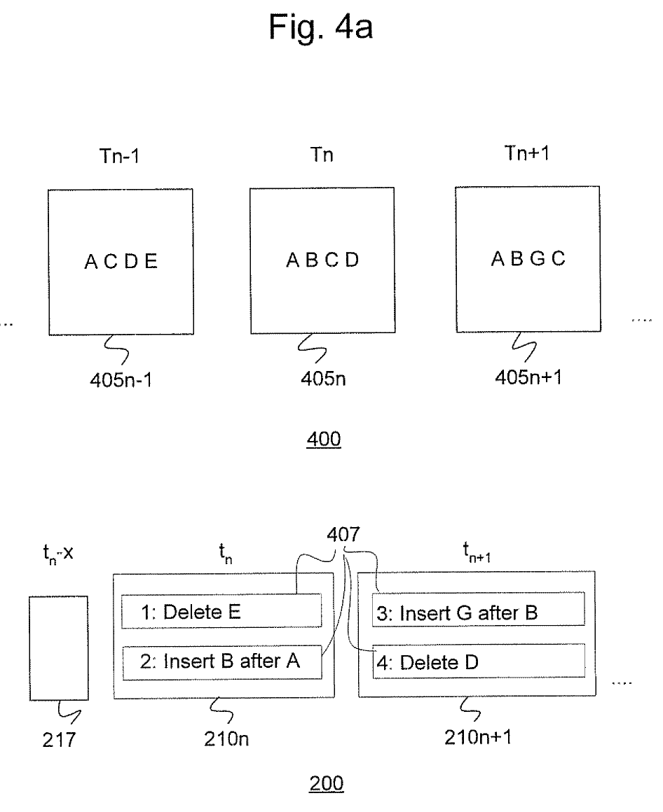

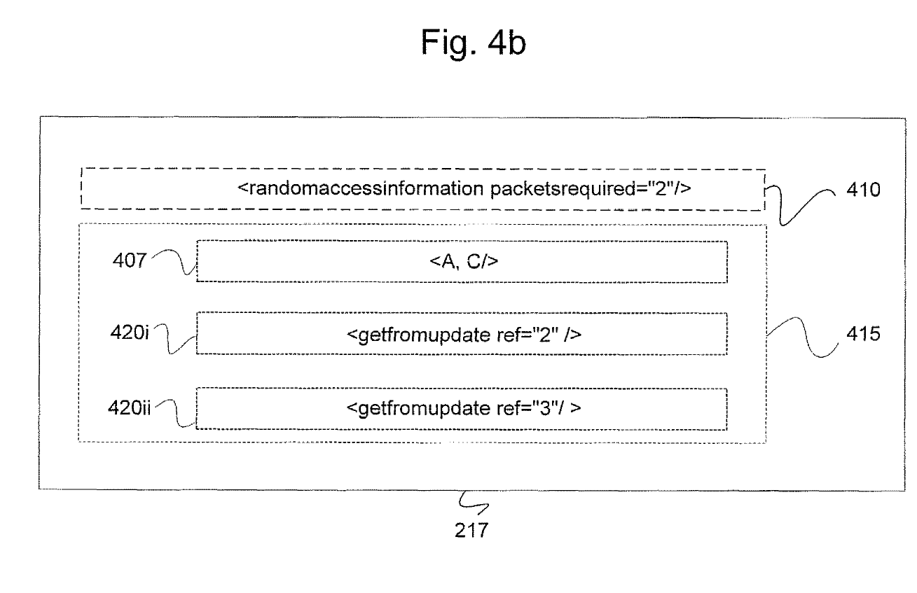

If it is found in step 305 that the received data object is a Distributed Random Access Point 217, then step 315 is entered. In step 315, the DRAP 217 is analysed in order to obtain information on which other data objects 217 have been referenced in the DRAP 217, and/or in order to determine the identity of the data elements to which the DRAP 217 refers. For a further discussion of this analysis, please refer to FIG. 4. In step 317, it is checked whether data elements in any subsequent data objects have referenced. If so, step 312 is entered, wherein the subsequent data objects 210 comprising referenced data elements are awaited and received. Step 325 is then entered. If in step 317 it is found that no subsequent data objects 120 are required, step 325 is entered directly after step 317. In implementations of the invention wherein a DRAP 217 always contains references to subsequent data objects 210, step 317 can be omitted, and step 320 entered directly after step 315. Similarly, in implementations where a DRAP 217 can only refer to previous data objects 210, steps 317 and 320 may be omitted, and step 325 may be entered directly after step 315.

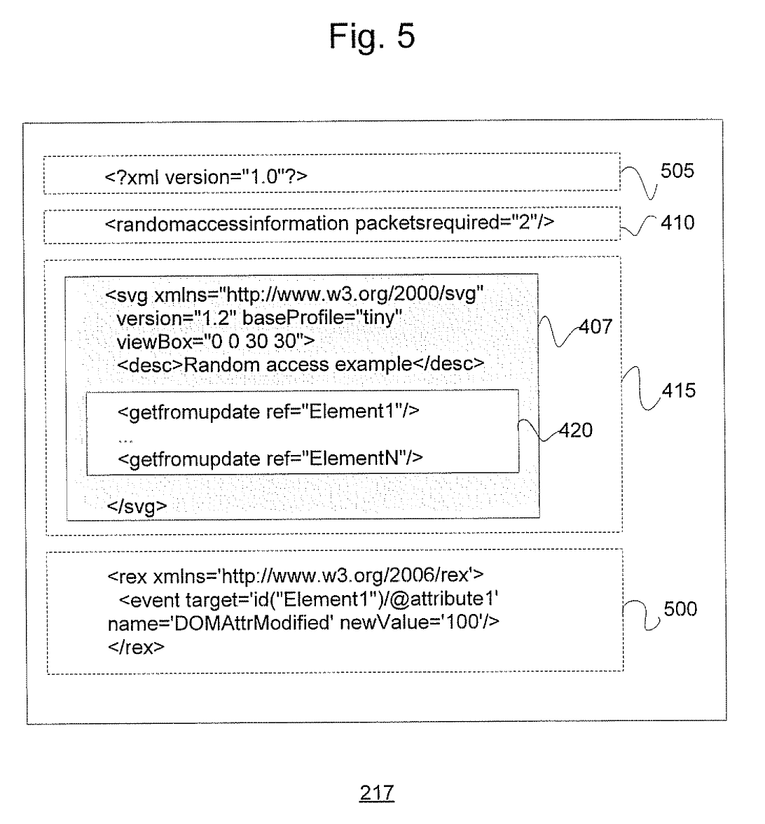

In step 325, the data elements, to which references are included in the DRAP 217, are identified in the other data objects 210 and copied, either into a separate data object or into the DRAP 217, depending on implementation of the invention. If the referenced data elements are copied into a separate data object, then any data in DRAP 217 that are also necessary for the re-construction of the scene will also be copied into such separate data object. If the referenced data elements are copied into the DRAP 217 itself, then a copied data element will replace the reference to that data element. Any information relating to which data objects 210 are necessary, and any information on the timing of execution of the DRAP, should preferably be removed prior to the execution of the DRAP 217 if the referenced data object is copied into the DRAP 217 itself (cf. the random access information 410 of FIG. 4b and FIG. 5). In the following, the DRAP 217 will be said to have become self-contained when all the necessary data elements have been identified and copied. When the DRAP 217 has become self-contained, step 330 is entered and the DRAP 217 is executed, whereby the scene will be re-constructed at the relevant timing. The term execution of the DRAP 217 shall here be construed to include the execution of a data object, different to the DRAP 217, into which the information obtainable by means of the DRAP 217 has been copied. After the execution of DRAP 217 in step 330, step 335 is entered, in which any further update data objects 210 are received and executed in the same way as if the DRAP 217 has not been used. A difference between step 312 entered by a client 110 to which a received DRAP 217 is of no relevance and therefore ignored, and the step 335, is that in step 335, any update data objects 210 that are received in step 320 are not executed but merely used for copying of data elements into DRAP 217, whereas such subsequent data objects 210 are generally executed by a client 110 that has ignored the DRAP 217.

Reference will now be made to FIG. 4, wherein a simple scenario in which a DRAP 217 is employed will be illustrated. In FIG. 4a, media in the form of a sequence of scenes 400 comprising the three scenes 405n−1, 405n and 405n+1 is shown, to be presented at a user interface/application 120 at times Tn−1, Tn and Tn+1, respectively. Scene 400n−1 consists of parts A, C, D, and E, scene 400n consists of parts A, B, C and D, whereas scene 400n+1 consists of parts A, B G and E.

FIG. 4a also shows a media representation 200 consisting of a data sequence comprising two update data objects 210n and 210n+1 relating to the differences between the scenes 405n−1 & 405n, and the differences between the scenes 405n and 405n+1, respectively. Update data objects 210n includes instruction data elements 407 containing instructions on how to obtain scene 405n when scene 405n−1 is known, and update data object 210 includes instructions on how to obtain scene 405n+1 when scene 405n is known. Update data objects 210n and 210n+1 may advantageously form part of a media representation 200 representing sequence of scenes 400, and will be conveyed to clients 110 at times tₙ and tₙ₊₁, occurring before times Tn and Tn+1, respectively.

Media representation 200 may advantageously also include one or several DRAPs 217, as is illustrated in FIG. 4a by DRAP 217 occurring in media representation 200 prior to update data object 210n. In FIG. 4b, an example of such a DRAP 217 that could be included in media representation 200 before update data objects 210n is illustrated. DRAP 217 of FIG. 4b has been encoded to be part of media representation 200 and conveyed to clients 110 prior to update data object 210n, at a time (tₙ−x). Furthermore, DRAP 217 refers to data elements in update data objects 210n and 210n+1, and enough data to re-construct scene 405n+1 will have been received at time Tn+1. Hence, from time Tn+1 an onwards, a client 110 trying to tune in to media representation 200 and having received DRAP 217 will be able to re-construct the sequence of scenes 400.

The payload of DRAP 217 includes a data element 410 which will be referred to as the random access information 410, as well as a data section 415. A purpose of the random access information 410 is to specify which update data objects 210 are required to make the DRAP 217 self-contained, and/or when the information obtained by means of DRAP 217 should be used to re-construct a scene. Information about when a scene 405 should be re-constructed by means of the DRAP 217 can be defined to be implicitly derivable from information about which update data objects 210 are required, and vice versa. For example, it may be defined that a scene 405 should be re-constructed by means of a DRAP 217 requiring n subsequent update data objects 210 at the time when the nth subsequent update data objects 210 should have been applied, i.e. the time stamp of the DRAP 217 is defined as the time stamp of the last of the update data objects 210 required. Alternatively, the random access information 410 could include a time stamp. In such case, a client 110 receiving the DRAP 125 could be adapted to assume that relevant information could be contained in any of the update data objects 210 received prior to the time of the time stamp.

By use of the random access information 410 a receiving client 110 may be provided with information about which update data objects 210 are required and when. Client 110 can use this information to efficiently utilize its buffering and memory resources. Furthermore, the use of random access information 410 enables efficient use of pointers, by for example enabling the use of relative links in the data section 415. The random access information 410 should advantageously be removed from DRAP 217 prior to execution of DRAP 217.

In the embodiment of DRAP 217 illustrated by FIG. 4b, random access information 410 of is on the format <randomaccessinformation packetsrequired=“n”/>. The random access information 410 of FIG. 4 has an attribute “packetsrequired” which specifies the number of subsequent update data objects 210 in media representation 200 that are required to complete a scene 405 in the sequence of scenes 400, hence the required update data objects 210 (“packets”) are defined as a series, either in the order they are sent or in the order they are stored in a file, or in another defined decoding order, whatever is applicable. The attribute “packetsrequired” may take the value of any natural number. From the random access information 410 of FIG. 4, it can also be deduced at what timing the scene 405 that can be obtained by means of DRAP 217 will be relevant—this is the timing of the scene 405 for which the n^{th} update data object 210 describes differences in relation to previous data objects 210. In the example given in FIG. 4, two update data objects 210 will be required to re-construct the scene 410n+1, and hence, the value of the attribute is 2 (and the timing at which scene 405n+1 will become relevant is Tn+1). Obviously, the parameter and attribute of the random access information 410 could have different names, for example such that the format of random access information 410 is <DRAP unitsrequired=“n”>, or <DRAPspecification dataobjectsrequired=“n”>.

Random access information 410 could alternatively be implemented in other ways. For example, instead of specifying that a series of “n” update data objects 210 are required to obtain the necessary information, each required update data object 210 could be explicitly specified in the data element random access information 410. A timestamp could then be added to the random access information 410 defining when the DRAP 217 is to be used, or a check could be introduced into the flowchart of FIG. 3 wherein it is checked whether all the data elements to which a reference has been made have been received.

A DRAP 217 does not have to include any random access information 410. For instance, if a DRAP 217 is encoded according to a standard wherein the number of other data objects 210 to which a DRAP 217 may refer is pre-determined, as well as the position of such other data objects 210 in media representation 200 in relation to the referring DRAP 217, a DRAP 217 may be encoded without any random access information. For example, if a DRAP 217 may refer to m preceding data objects and k subsequent data objects 210, then a decoder 115 would know that the DRAP 217 is self-contained when the kth subsequent data object has been received. The timing for the execution of the DRAP 217 could also be pre-determined, for example at the timing of the kth subsequent data object 210.

Data section 415 of DRAP 217 of FIG. 4, as illustrated in FIG. 4b, comprises data elements by means of which the data necessary for re-constructing the scene 405n+1 may be obtained. Data section 415 of FIG. 4b comprises two distinguishable types of data elements: instruction data elements 407 which should preferably be compliant with the standard and language according to which the data sequence is encoded (such as for example SVG/XML), and reference data elements 420, which include references to data elements of other data objects 210, and which will be replaced, at least in part, by such referenced data elements during processing of the DRAP 217, prior to the execution of the DRAP 217. When data elements to which the reference data elements 420 refer have been copied into the DRAP 217, the DRAP 217 should preferably be fully compliant with the standard and language according to which the data sequence is encoded.

The reference data element 420 of DRAP 217 of FIG. 4b is of the syntax <getfromupdate ref=“reference”>, wherein the attribute “ref” specifies an identity appearing in another data object 210, i.e. “reference” is the identity of a data element 407 in the another data object 210. The position of <getfromupdate ref=“reference”> in the DRAP 217 can advantageously provide information about the position of DRAP 217 into which the referenced data element should be copied. Other syntaxes of the DRAP 217 than that of DRAP 214 of FIG. 4b may alternatively be used. For example, a reference data element 420 may comprise two separate parts, wherein a first part comprises the reference and provides an identification of the referenced instruction data element 407 to be copied from a subsequent data object 210, and a second part includes the identification. The first part of a reference data element 420 in this embodiment could for example have the syntax <getfromupdate source=“identity1” target=“identity2”>. The second part of reference data element 420 could then be <identity2/>. The first and second parts of the reference data element 420 could then be placed in the data section 415 independently of each other: for example, the first part could for example be placed in the beginning of the data section 415, and the second part could be placed before, after or between instruction data elements 407. The position of the second part in DRAP 217 may in this implementation provide information about the position into which the referenced data element should be copied. Yet other syntaxes could alternatively be employed. For example, a reference data object 420 may include information specifying in which particular data object 210 the referenced data element occurs.

Depending on the sequence of scenes 400 to be represented by means of the media representation 200, as well as on how the encoding of media representation 200 was performed, the data section 415 of a DRAP 217 may consist of reference data elements 420 only, and include no instruction data elements 407. During processing of DRAP 217, the reference data elements 420 are replaced by the referred data elements 407 of the other data objects 210, thus making the DRAP 217 self-contained.

In the example given by FIG. 4, each of the reference data elements 420 of data section 415 refer to an entire instruction data element 407 of another data object 210. However, a reference data element 420 may refer to any referable data element in another data object 407, such as an attribute or other part of an instruction data element 407, to a group of instruction data elements 407, to other types of data elements than instruction data elements such as identification data elements, etc. As an example, consider a media representation 200 defined by use of the DIMS standard, wherein an update data object 210 comprises the following insert command,

<Insert id=”insert1” ref=″root″>

<g id=″object1″ visibility=″hidden″/>

</Insert>

then a DRAP 217 could for example refer to “insert1”, in order to copy the entire insert command into the DRAP 217, or refer to “object1”, in order to copy the data element <g id=“object1” visibility=“hidden”/> into the DRAP 217.

Furthermore, in the example given by FIG. 4, the instruction data elements 407 to which the reference data elements 420 refer are copied into the DRAP 217, to be executed upon execution of the DRAP 217. Alternatively, instruction data elements 407 to which reference data elements 420 refer may be executed on the DRAP 217 itself, so that the execution of the referenced instruction element 420 is performed prior to the execution of the DRAP 217, in order to change the DRAP 217.

As mentioned above, a DRAP 217 can further include an update section, comprising updates that need to be made to the data section 415. For example, in case of dynamic data, data elements 407 copied into the data section of a DRAP 217 may have slightly changed, and the updates may describe such changes and hence be used to modify such data elements that have changed. The updates could advantageously be performed after the DRAP 217 has become self-contained.

An exemplary DRAP 217 including an update section 500 is given in FIG. 5. Furthermore, the DRAP 217 of FIG. 5 comprises random access information 410, a data section 415 and a further data element 505, which may contain data relevant to the interpretation of the DRAP 217, such as for example information about a version of a language being used in the DRAP 217. In FIG. 5, the data element 505 specifies that XML version 1.0 is used in the DRAP 217.

The data section 415 of DRAP 217 of FIG. 5 comprising an instruction data element 407 including data elements to be executed when the DRAP 217 is complete, as well as reference data elements 420 including references to data elements in other data objects 210. In the example given in FIG. 5, the reference data elements 420 are located within the instruction data element 407, so that the data elements in other data objects 210 to which the reference data elements 410 refer, can fill holes in the instruction data element 407 when copied into the instruction data element 407. Hence, reference data elements 420 can be used to fill in holes in instruction data elements 407 of the DRAP 217, as well as to provide complete instructions from other data objects 210.

The updates section 500 of DRAP 217 of FIG. 5 includes updates to be made to instruction data element 407. The updates section 500 of DRAP 217 in FIG. 5 uses a standard for defining updates referred to as REX (Remote Events for XML). However, any standard for defining updates may be used, such as for example LASeR Commands).

In the example of a DRAP 217 given in FIG. 5, the updates section 500 stipulates that an attribute “attribute1” in an instruction data element 407 “Element1” obtained from a subsequent update data object 210 should take a new value (i.e. the value 100). (The value of attribute “xmlns” comprises information about what XML Namespace (i.e. language) is used for the update).

DRAP 217 of FIG. 5 is described by use of XML in clear text. This is an efficient way of describing information relating to scenes in a media conveying visible information. However, other manners of describing the DRAP 217 may alternatively be used, such as for example binarized xml. Examples of binarization methods include gzip, compress, deflate and BiM (Binary MPEG format for XML), etc. Furthermore, XML data may or may not be encrypted.

As discussed above, a DRAP 217 uses references to other data objects 210 in order to convey the full information about a particular scene 405 of a sequence of scenes 400. An encoder of a content creator 125 may define a DRAP 210 so that it refers to any number of data objects 210, for example including all data objects 210 within a particular interval, or to selected data objects 210. In the case of information transmission by means of the DIMS standard, it is often advantageous that a DRAP 217 refers to all update data objects 210 within an interval due to the nature of DIMS. In this case, it is advantageous to define the number of update data objects 210 required to complete a scene 405 as a series, such as for example the n update data objects 210 directly following the DRAP 217 (see above).

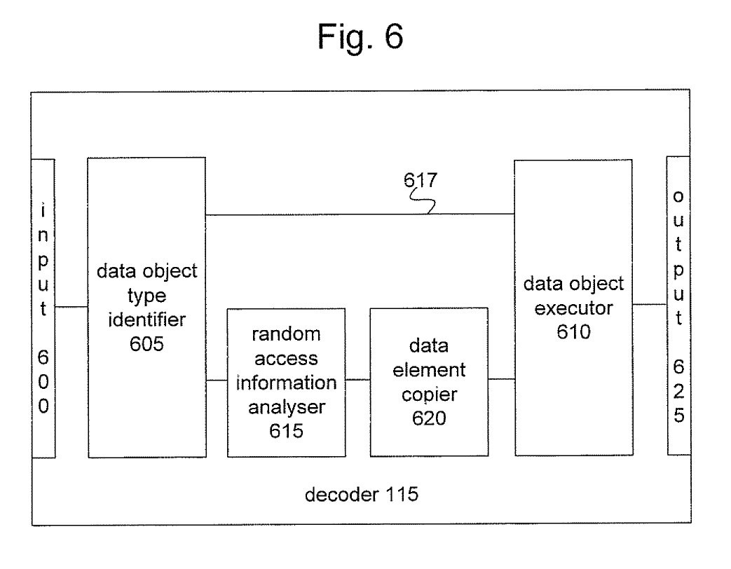

In FIG. 6, an embodiment of a decoder 115 used to decode the media representation 200 is schematically illustrated. Decoder 115 of FIG. 6 comprises an input 600 for receiving the media representation 200, which is connected to a data object type identifier 605. Data object type identifier 605 is further connected to a data object executor 610 via at least two different connections: via a first connection 617 as well as via a random access information analyser 615 and a data element copier 620. Data executor 610 is connected to an output 625. Data object type identifier 605 is inter alia adapted to check whether a received data object is a DRAP 217, and to convey a data object identified as a DRAP 217 to the data object executor 615 via the random access information analyser 615 and the data element copier 620. Data object type identifier 605 is further adapter to conveying a data object which has been identified as not being a DRAP 217 to data object executor 610 via connection 617.

Random access information analyser 615 is adapted to analyse the random access information 420 of a DRAP 217, in order to determine which other data objects 210 are required in order to make the DRAP 217 self-contained, and/or at what timing the DRAP 217 should be executed. Data element copier 620 is adapted to read any reference data elements 420 in a DRAP 217, and identify data element(s) in another data object 210 to which the reference data element(s) 420 refer. Data element copier 620 is further adapted to coping such identified data element(s) into the DRAP 217 (or, similarly, into another data object, see above). The DRAP 217, into which the referenced data elements have been copied, is then conveyed to the data object executor 610 to be executed at the appropriate timing. Data object executor 610 is connected to an output 625, which may be further connected to for example a user interface 120.

The decoder 115 of FIG. 6 should be seen as an example only, and a decoder capable of decoding a media representation 100 including DRAPs 217 may be implemented in many different ways. For example, the random access information analyser 615 may be omitted, and the data element copier 620 may be adapted to search any data objects appearing nearby the DRAP 127 in the media representation 200, such as for example the n subsequent data objects 210. The execution of the DRAP 217 could then be set to occur after the nth subsequent data object 210 has been received. In an implementation of the invention wherein a DRAP 217 may refer to other data objects 210 appearing before the DRAP 217 in the media representation 200, decoder 115 may advantageously comprise a buffer for buffering incoming data objects 210 until a DRAP 217 is received. In a standard wherein a DRAP 217 may only refer to m preceding data objects 210, such buffer could for example be arranged to store the m+1 last received data objects 210.

The DRAP 217 can be ignored during normal playback of a sequence of scenes 400. Hence, a decoder 115 used to decode media representation 200 including DRAPs 217 does not have to be reset during normal playback. The DRAPs 217 do not contain any information required by a decoder 115 during normal playback. However, a DRAP 217 can be used by the decoder 115 for error recovery, if need be. If the decoder 115 has detected an error in the sequence of scenes retrieved from the update data objects 210, a DRAP 217 may be used to reset the decoder 115.

The decoder 115 and content creator 125 can advantageously be implemented by means of appropriate hardware and/or software. Software by means of which the decoder 115 or content creator 125 is implemented could be stored on memory means, and could be transmitted between different memory means via a carrier signal.

A DRAP 217 is orthogonal to transport/storage type, and can be used for example when tuning in to a streaming session, when recovering from lost packets in a streaming session, or as shadowed random access points for navigating in a file.

As mentioned above, the media representation 200 of which DRAPs 217 form a part can be stored in files or streamed over a network. The files can be used for example by a server, (cf. data source 105 of FIG. 1), for streaming data, unicast file download (e.g. over HTTP), broadcast file download (e.g. over FLUTE) or progressive download (e.g. over HTTP). DRAPs 217 can also be streamed using unicast/multicast/broadcast streaming (e.g. using RTP). A DRAPs 217 may also be used in hinted files for streaming, wherein the DRAP 217 can be placed in the file as a sample which is marked as a random access point (cf. how SVG scenes are conventionally placed in hinted files). DRAPs 217 can be added as shadowed random access points which may be used for file navigation, e.g. search, fast forward and rewind. Since a DRAP 217 is independent of the method of transport, a DRAP 217 can be used in all types of transport and storage, and in particular in all types of DIMS transport and storage.

The DRAP 217 according to the invention has less overhead than conventional random access points 215. The overhead of the DRAP 217 is reduced by utilizing information from other data objects, typically update data objects 210. Instead of each random access point describing, for example, an SVG scene from scratch, data elements 407 defined in nearby update data objects 210 can be utilized. By use of DRAPs 217, the bandwidth cost of defining a data element in both a random access point and in an update data object 210 is reduced to a single definition in an update data object 210 and a reference from a DRAP 217 to this update data object 210.

DRAPs 217 may be included in a media representation 200 at periodic intervals, in order to enable for newcomer clients 110 to tune in the media representation 200 and for already tuned-in clients 110 to perform error recovery, for example error recovery from packet losses, if desired, as well as to facilitate file navigation Due to the low overhead and the fact that a DRAP 217 may be ignored during normal playback, DRAPs 217 can be included very frequently in streams or files, thus enabling quick tune-in or recovery, or file navigation at high granularity. The DRAP 217 can for example be sent periodically in a data stream, such as a DIMS stream, or could be included at periodic intervals in a file, such as a 3GP file. Alternatively, a DRAP 217 could be included in a media representation 200 at irregular intervals.

An advantage of the invention is that a random access point can be provided in the data sequence of a media representation 200 while maintaining any interactivity, for example instructions given by the client 110 regarding the construction of a scene 405, may be retained. Conventionally, when differences between a scene 405n and the previous scene 405n−1 are large, a new scene data object 205 or essential Random Access Point 215 would be included in the media representation 200. Such scene data object/essential RAP 215 would provide already tuned-in clients 110 with the complete information about the scene, as well as provide new-corner clients 110 with all necessary information for tuning-in to the data sequence. However, by conventional scene data objects 205 and essential Random Access Points 215, any interactivity is zeroed. By use of the invention, the information relating to any interactivity may be conveyed by a DRAP 217, and the information relating to the change of scene can be conveyed in an update data object 210 to which the DRAP 217 refers.

One skilled in the art will appreciate that the present invention is not limited to the embodiments disclosed in the accompanying drawings and the foregoing detailed description, which are presented for purposes of illustration only, but it can be implemented in a number of different ways

1. A method of reconstructing media from a media representation wherein the media representation includes a plurality of encoded data objects comprising at least one data element, comprising:
receiving an encoded data object comprising at least one reference to a data element in another encoded data object of the media representation; and
re-constructing the media by use of information associated with said referenced data element.

2. The method according to claim 1, further comprising
analyzing a random access information part of the received encoded data object in order to determine in which part of the media representation the referenced data element may be found and/or at what timing the re-constructing is to be performed.

3. The method according to claim 1, further comprising
receiving the another encoded data object;
copying the data element of the another encoded data object to which the reference refers into a data object; and wherein the re-constructing comprises executing the data object into which the data element has been copied.

4. The method according to, claim 1 wherein the encoded data object comprising the reference is received and/or stored separately from at least a part of the other encoded data objects of the media representation.

5. A method according to claim 1, wherein the re-constructing of media is performed in order to tune in to a data transmission session, or to perform error recovery, or in order to navigate in a file.

6. A computer program product for reconstructing media from a media representation wherein the media representation includes a plurality of encoded data objects comprising at least one data element, comprising:
the computer program product comprising computer program code operable to, when run on processing means, re-construct the media by use of information associated with a data element in a first encoded data object in the media representation to which a reference in a second encoded data object in the media representation is referring.

7. An apparatus for reconstructing media from a media representation including a plurality of encoded data objects comprising at least one data element, said apparatus comprising:
an input for receiving the media representation; comprising the apparatus being arranged to identify, in the received media representation, an encoded data object that comprises a reference to a data element in a other encoded data object of the media representation; the apparatus being further arranged to reconstruct media by using said reference.

8. The apparatus of claim 7, wherein the apparatus is further arranged to determine in which part of the media representation the referenced data element(s) may be found and/or at what timing the reconstructing is to be performed.

9. An apparatus for creating a media representation from a sequence of scenes, wherein the apparatus is arranged to create the media representation to include a plurality of encoded data objects so that at least one encoded random access point data object comprises at least one reference to a data element in another encoded data object, by use of which referenced data element(s) and information in the encoded random access data point data object a scene may be re-constructed.

10. An encoded random access point data object adapted to be included in a media representation comprising a plurality of encoded data objects, said encoded random access point data object being comprising:
a reference to a data element in another encoded data object of said plurality of encoded data objects, wherein said referenced data element at least partly describes how to reconstruct media from said media representation.

11. The data object of claim 10, further comprising random access information including information from which it may be derived in which part of the media representation the data element may be found and at which timing the media should be re-constructed.

12. The data object of claim 10, wherein the data object further includes a second reference referring to a sequence of another encoded data objects appearing after the data object in the media representation and in which sequence the data element may be found.

13. The data object of claim 10, wherein the reference to a data element is divided into two parts, of which a first part identifies the data element and a second part provides information on how the data element is to be used in the re-constructing of media.

14. The data object of claim 10, further comprising identification data identifying the data object as a data object comprising a reference to a data element in another encoded data object in the media representation.

15. A media representation including a data object according to claim 11, wherein the media representation is a primary or secondary stream encoded according to the DIMS standard.

16. A media container or document divided into an encoded self-contained part and a number of updates that are applied sequentially, one after the other, and where redundant information gives instructions on how to reconstruct media of the media container at a certain instant or time by referring to data elements of said updates and possibly in combination with data elements contained in said redundant information.

17. The media container of claim 16 wherein said redundant information refers to updates sent or stored before or after said redundant information.

18. The media container of claim 16, wherein said redundant information refers to a number of consecutive updates after the said redundant information.

19. The media container of claim 17, wherein the media container uses any scene description language in clear text or binarized, including XML.

20. The media container of claim 17, wherein the redundant information is stored in a file.

21. A method of reconstructing media in a media representation including a plurality of encoded objects containing at least one element each, said method comprising the steps of:
referring to an element in at least one encoded object of said plurality of encoded objects;
reconstructing media by using information associated with said element.

22. An apparatus for reconstructing media in a media representation including a plurality of encoded objects containing at least one element each, said apparatus comprising:
means for reconstructing media by using a reference to an element in an encoded object of said plurality of objects.

23. A media representation including a plurality of encoded objects containing at least one element each, said media representation comprising:
a reference to an element in an encoded object of said plurality of encoded objects, wherein said reference at least partly describes how to reconstruct media of said media representation.
